(19) United States
(12) Patent Application Publication
(10) Pub. No.: US 2023/0265318 A1
(43) Pub. Date: Aug. 24, 2023

(54) DOUBLE-SIDED TISSUE TAPE AND RELATED ARTICLE

(71) Applicant: 3M INNOVATIVE PROPERTIES COMPANY, St. Paul, MN (US)

(72) Inventors: Ramesh C. Lhila, Woodbury, MN (US); Matthew R.C. Atkinson, Stillwater, MN (US); Duane D. Fansler, Dresser, WI (US); Travis Q. Gregar, Maplewood, MN (US); Anthony F. Schultz, Forest Lake, MN (US); Nassor A. Shabibi, Cottage Grove, MN (US)

(21) Appl. No.: 18/024,037

(22) PCT Filed: Sep. 3, 2021
(86) PCT No.: PCT/IB2021/058072

§ 371 Date: Feb. 28, 2023

Related U.S. Application Data
(60) Provisional application No. 63/075,478, filed on Sep. 8, 2020.
(60) Provisional application No. 63/074,850, filed on Sep. 4, 2020.

(51) Int. Cl. C09J 7/38; C09J 7/21

(52) U.S. Cl. CPC C09J 7/385; C09J 7/21; C09J 2301/1242; C09J 2301/302; C09J 2301/416; C09J 2400/283; C09J 2401/006; C09J 2433/00

(57) ABSTRACT

The double-sided pressure-sensitive adhesive tape includes a tissue support having a first face and a second face, a first pressure-sensitive adhesive disposed on the first face of the tissue support, and a second pressure-sensitive adhesive disposed on the second face of the tissue support. The first pressure-sensitive adhesive and the second pressure-sensitive adhesive are each crosslinked acrylic-based pressure-sensitive adhesives that are the same or different from each other, and the tissue support is impregnated by the first pressure-sensitive adhesive and the second pressure-sensitive adhesive. The article includes a first substrate and the double-sided pressure-sensitive adhesive tape, in which the first pressure-sensitive adhesive is bonded to a surface of the first substrate.

### CROSS-REFERENCE TO RELATED APPLICATION

This application claims priority to U.S. Provisional Application Nos. 63/074,850, filed Sep. 4, 2020, and 63/075,478, filed Sep. 8, 2020, the disclosures of which are incorporated by reference in their entirety herein.

### BACKGROUND

Pressure-sensitive adhesives (often referred to as PSAs) and tapes including them are useful for a variety of purposes. Such tapes can be produced using methods including coating an adhesive polymer composition in solvent or an emulsion onto a support and subsequently removing the solvent or water. Solvent-free adhesives and tapes can be produced by hot melt processes or by irradiating an adhesive composition including one or more acrylic monomers and a photoinitiator using ultraviolet light. Adhesives can be formed on a variety of supports to make tapes. Such supports include polymer films, nonwovens and other fabrics, and paper.

U.S. RE32249 (Esmay) describes a linerless double-coated pressure sensitive adhesive tape that can be transparent when a plastic film is used as a support. Chinese Patent Application publication number CN 109810648, published May 28, 2019, describes an ultraviolet light-curing nonwoven adhesive tape, which is said to be transparent.

### SUMMARY

We have found that common processes of producing tissue tapes (e.g., solvent or emulsion coating and hot melt processes) make products that are opaque or translucent and subject to tissue splitting, in which the adhesive does not stay bonded to the tissue when the tape is applied to substrate and subsequently removed. Typically, and advantageously, the double-sided pressure-sensitive adhesive tape disclosed herein is unexpectedly see-through even though an opaque tissue, not a transparent plastic film, is present between two layers of adhesives. The surface of the substrate to which the tissue tape is applied can therefore remain visible. Also, in many embodiments, the double-sided pressure-sensitive adhesive tape disclosed herein is an easy-to-tear tape that advantageously does not exhibit the problem of tissue splitting.

In one aspect, the present disclosure provides a double-sided pressure-sensitive adhesive tape that includes a tissue support having a first face and a second face, a first pressure-sensitive adhesive disposed on the first face of the tissue support, and a second pressure-sensitive adhesive disposed on the second face of the tissue support. The first pressure-sensitive adhesive and the second pressure-sensitive adhesive are each crosslinked acrylic-based pressure-sensitive adhesives that are the same or different from each other, and the tissue support is impregnated by the first pressure-sensitive adhesive and the second pressure-sensitive adhesive. In some embodiments, the double-sided pressure-sensitive adhesive tape exhibits not more than 65 percent haze as measured by ASTM D-1003. In some embodiments, the double-sided pressure-sensitive adhesive tape has not more than 25 percent area occupied by air bubbles as measured by optical microscopy. In some embodiments, the first pressure-sensitive adhesive, the second pressure-sensitive adhesive, or both the first pressure-sensitive adhesive and the second pressure-sensitive adhesive are derived from a composition that includes at least one alkyl acrylate monomer having from 4 to 18 carbon atoms and a polymer prepared from the partial polymerization of the at least one alkyl acrylate monomer.

In another aspect, the present disclosure provides an article including a first substrate and the double-sided pressure-sensitive adhesive tape. The first pressure-sensitive adhesive is bonded to a surface of the first substrate. In some embodiments, the article includes a second substrate in which the second pressure-sensitive adhesive is bonded to a surface of the second substrate. The surface of the first substrate and/or the second substrate can include at least one of metal, glass, a polymer, paper, a painted surface, or a composite.

In this application, terms such as “a”, “an” and “the” are not intended to refer to only a singular entity but include the general class of which a specific example may be used for illustration. The terms “a”, “an”, and “the” are used interchangeably with the term “at least one”. The phrases “at least one of” and “comprises at least one of” followed by a list refers to any one of the items in the list and any combination of two or more items in the list. All numerical ranges are inclusive of their endpoints and non-integral values between the endpoints unless otherwise stated (e.g. 1 to 5 includes 1, 1.5, 2, 2.75, 3, 3.8, 4, and 5, and the like).

The terms “first” and “second” are used in this disclosure in their relative sense only. It will be understood that, unless otherwise noted, those terms are used merely as a matter of convenience in the description of one or more of the embodiments.

The term “layer” refers to any material or combination of materials on or overlaying a substrate.

Words of orientation such as “disposed on,” “covering,” and “overlaying,” for describing the location of various layers, refer to the relative position of a layer with respect to a horizontally-disposed, upwardly-facing substrate. It is not intended that the substrate, layers, or articles encompassing the substrate and layers, should have any particular orientation in space during or after manufacture.

The term “(meth)acrylate” with respect to a monomer, oligomer or polymer means a vinyl-functional alkyl ester formed as the reaction product of an alcohol with an acrylic or a methacrylic acid.

The term “(co)polymer” or “(co)polymeric” includes homopolymers and copolymers, as well as homopolymers or copolymers that may be formed in a miscible blend, e.g., by coextrusion or by reaction, including, e.g., transesterification. The term “copolymer” includes random, block, graft, and star copolymers.

The term “crosslinking” refers to joining polymer chains together by covalent chemical bonds, usually via crosslinking molecules or groups, to form a network polymer. A crosslinked polymer is generally characterized by insolubility but may be swellable in the presence of an appropriate solvent.

The above summary of the present disclosure is not intended to describe each disclosed embodiment or every implementation of the present disclosure. The description that follows more particularly exemplifies illustrative embodiments. It is to be understood, therefore, that the drawings and following description are for illustration purposes only and should not be read in a manner that would unduly limit the scope of this disclosure.

### BRIEF DESCRIPTION OF THE DRAWINGS

The disclosure may be more completely understood in consideration of the following detailed description of various embodiments of the disclosure in connection with the accompanying drawings, in which:

FIG. 1 is a side view of an embodiment of a double-sided pressure-sensitive adhesive tape of the present disclosure;

FIG. 2 is a side view of an embodiment of an article of the present disclosure in which the double-sided pressure-sensitive adhesive tape is adhered to two substrates;

FIGS. 3A and 3B are optical images of Example 1 obtained using a digital microscope before and after, respectively, converting to grayscale for the calculation of percent area of air bubbles;

FIGS. 4A and 4B are optical images of Comparative Example C3 obtained using a digital microscope before and after, respectively, converting to grayscale for the calculation of percent area of air bubbles;

FIG. 5 is an image of a cross section of Example 1 obtained by scanning electron microscopy;

FIG. 6 is an image of a cross section of Comparative Example C3 obtained by scanning electron microscopy; and

FIG. 7 is an image of a cross section of Comparative Example C5 obtained by scanning electron microscopy.

### DETAILED DESCRIPTION

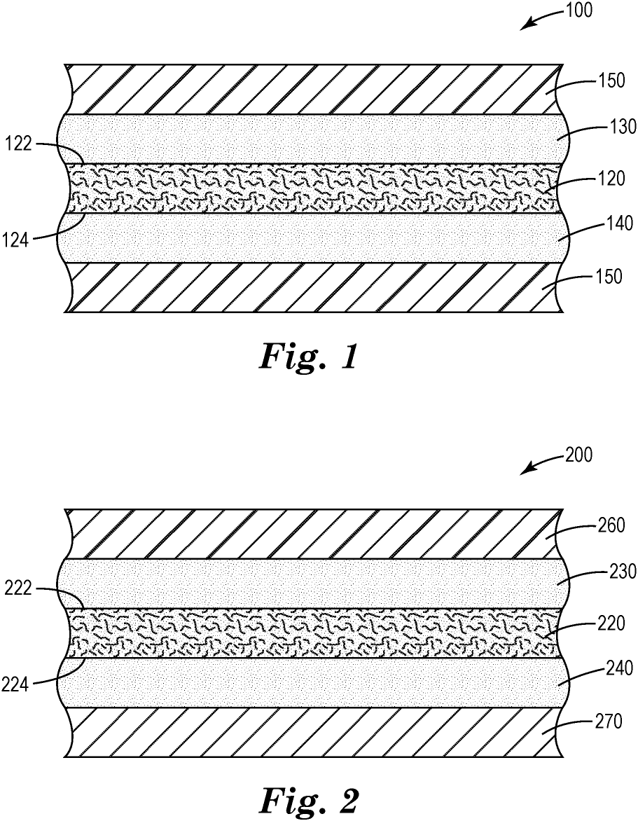

FIG. 1 illustrates an embodiment of a double-sided pressure-sensitive adhesive tape 100 of the present disclosure. The tape 100 includes a tissue support 120 having a first face 122 and a second face 124. A first pressure-sensitive adhesive 130 is disposed on the first face 122 of the tissue support 120. A second pressure-sensitive adhesive 140 is disposed on the second face 124 of the tissue support 120. The first pressure-sensitive adhesive 130 and the second pressure-sensitive adhesive 140 are shown to impregnate the tissue support. In the illustrated embodiment, the first pressure-sensitive adhesive 130 and the second pressure-sensitive adhesive 140 are attached to release liners 150.

The double-sided pressure-sensitive adhesive tape of the present disclosure includes a tissue support. The term “tissue support” as used herein refers to a support that is made from paper and/or cellulosic fibers. Paper is traditionally regarded as a thin material produced by pressing together wet laid cellulose fibers from a water suspension and drying them. The fibers in paper are typically short and refined, and drying them together is generally believed to create a hydrogen-bonded sheet. As reported in Russell, S.J. Handbook of Nonwovens; Woodhead Publishing: Cambridge, England, 2007; p. 2, the European Disposables and Nonwovens Association (EDANA), excludes paper from the definition of nonwoven. Further according to EDANA, wetlaid nonwovens have more than 50% by mass of their fibrous content made up of fibers (excluding chemically digested vegetable fibers) with a length to diameter ratio greater than 300. In contrast to nonwovens, tissue has less than 50%, 40%, or 30% by weight of its fibrous content made up of fibers with a length to diameter ratio greater than 300. In other words, tissue has greater than 50%, 60%, or 70% by weight of its fibrous content made up of fibers with a length to diameter ratio less than 300. Fiber length to diameter ratios can be measured according to TAPPI T 401 Fiber Analysis of the tissue support as manufactured before either of the first or second pressure-sensitive adhesive is disposed on the first or second face. Fiber length to diameter ratios can also be measured with microscopes or stereoscopes using calibrated oculars or rulers. Furthermore, the definition of tissue excludes woven, knitted, tufted, and stitchbonded materials and materials felted by wet-milling. In some embodiments, the tissue support in the double-sided pressure-sensitive adhesive tape of the present disclosure is not engineered to a level of structural integrity by physical and/or chemical means other than hydrogen bonding.

Tissue supports useful for the double-sided pressure-sensitive adhesive tape of the present disclosure can have a variety of basis weights. In some embodiments, the tissue support has a basis weight in a range from 7 grams per square meter to 26 grams per square meter, corresponding to 4.3 pounds per ream to 16 pounds per ream. In some embodiments, the tissue support has a basis weight in a range from 10 grams per square meter to 26 grams per square meter, 10 grams per square meter to 20 grams per square meter, 7 grams per square meter to 20 grams per square meter, or 8 grams per square meter to 16 grams per square meter. These values are the basis weights of the tissue support as manufactured before either of the first or second pressure-sensitive adhesive is disposed on the first or second face.

As described above, the double-sided pressure-sensitive adhesive tape of the present disclosure has desirable optical properties that are different from the tissue itself. One measurable optical property that is a useful indicator of the beneficial properties of the double-sided pressure-sensitive adhesive tape is haze. Haze is the ratio of diffuse transmittance to total transmittance, where the diffuse transmittance is measured with the direct beam entering a light trap and thus not contributing to the measurement. In some embodiments, the tissue support exhibits at least 80, 85, or 90 percent haze. These values represent the haze of the tissue support as manufactured before either of the first or second pressure-sensitive adhesive is disposed on the first or second face. Haze is measured using a BYK-Gardner Hazegard instrument that conforms to ASTM D-1003 “Standard Test Method for Haze and Luminous Transmittance of Transparent Plastics.”

The double-sided pressure-sensitive adhesive tape of the present disclosure includes first and second pressure sensitive adhesives (PSAs). The first pressure-sensitive adhesive and the second pressure-sensitive adhesive are each crosslinked acrylic-based pressure-sensitive adhesives that are the same or different from each other. In some embodiments, the first PSA and the second PSA are the same PSA. In some embodiments, the first PSA and the second PSA are different PSAs.

PSAs are well known to those of ordinary skill in the art to possess properties including the following: (1) aggressive and permanent tack, (2) adherence with no more than finger pressure, (3) sufficient ability to hold onto an adherend, and typically, (4) sufficient cohesive strength to be cleanly removable from the adherend. Materials that have been found to function well as PSAs are polymers designed and formulated to exhibit the requisite viscoelastic properties resulting in a desired balance of tack, peel adhesion, and shear holding power. One method useful for identifying pressure sensitive adhesives is the Dahlquist criterion. This criterion defines a pressure sensitive adhesive as an adhesive having a creep compliance of greater than 3 × 10⁻⁶ cm²/dyne as described in Handbook of Pressure Sensitive Adhesive Technology, Donatas Satas (Ed.), 2nd Edition, p. 172, Van Nostrand Reinhold, New York, NY, 1989. Alternatively, since modulus is, to a first approximation, the inverse of creep compliance, pressure sensitive adhesives may be defined as adhesives having a storage modulus of less than about 3 × 10⁵ N/m².

As used herein, the term “acrylic” or “acrylate” includes compounds having at least one of acrylic or methacrylic groups. Useful acrylic PSAs can be made, for example, by combining at least two different monomers (i.e., first and second monomers). Examples of suitable first monomers include those represented by Formula I:

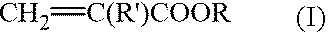

wherein R′ is hydrogen or a methyl group and R is an alkyl group having 4 to 18 carbon atoms which may be linear, branched, cyclic, or polycyclic. Examples of suitable first monomers represented by Formula I include n-butyl acrylate, s-butyl acrylate, t-butyl acrylate, n-pentyl acrylate, isopentyl acrylate, hexyl acrylate, cyclohexyl acrylate, heptyl acrylate, isoamyl acrylate, 2-ethylhexyl acrylate, n-octyl acrylate, 2-octyl acrylate, isooctyl acrylate, n-nonyl acrylate, isononyl acrylate, n-decyl acrylate, isodecyl acrylate, n-dodecyl acrylate, isomyristyl acrylate, n-tridecyl acrylate, n-tetradecyl acrylate, stearyl acrylate, isostearyl acrylate, isobornyl acrylate, 2-methylbutyl acrylate, 4-methyl-2-pentyl acrylate, methacrylates of the foregoing acrylates, and combinations thereof. Suitable first monomers further include mixtures of at least two or at least three structural isomers of a secondary alkyl (meth)acrylate of Formula (II):

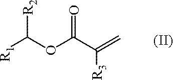

wherein R¹ and R² are each independently a C₁ to C₃₀ saturated linear alkyl group; the sum of the number of carbons in R¹ and R² is 7 to 31; and R³ is H or CH₃. The sum of the number of carbons in R¹ and R² can be, in some embodiments, 7 to 27, 7 to 25, 7 to 21, 7 to 17, 7 to 11, or 7. Methods for making and using such monomers and monomer mixtures are described in U.S. Pat. No. 9,102,774 (Clapper et al.).

Examples of suitable second monomers useful for preparing acrylic PSAs include an acrylic acid (e.g., acrylic acid, methacrylic acid, itaconic acid, maleic acid, and fumaric acid), an acrylamide (e.g., acrylamide, methacrylamide, N-ethyl acrylamide, N-hydroxyethyl acrylamide, N-octyl acrylamide, N-t-butyl acrylamide, N,N-dimethyl acrylamide, N,N-diethyl acrylamide, N-ethyl-N-dihydroxyethyl acrylamide, and methacrylamides of the foregoing acrylamides), a hydroxyl- or amino-substituted acrylate (e.g., 2-hydroxyethyl acrylate, 3-hydroxypropyl acrylate, 2-hydroxybutyl acrylate, 4-hydroxybutyl acrylate, 6-hydroxyhexyl acrylate, 8-hydroxyoctyl acrylate, 10-hydroxydecyl acrylate, 12-hydroxylauryl acrylate, (4-hydroxymethylcyclohexyl)methyl acrylate, dimethylaminoethyl acrylate, t-butylaminoethyl acrylate, aminoethyl acrylate, N,N-dimethyl aminoethyl acrylate, N,N-dimethylaminopropyl acrylate, and methacrylates of the foregoing acrylates), N-vinyl pyrrolidone, N-vinyl caprolactam, an alpha-olefin, a vinyl ether, a vinyl ester (vinyl acetate, vinyl benzoate, vinyl 4-tert-butylbenzoate, vinyl cinnamate, vinyl decanoate, vinyl neodecanoate, vinyl neononanoate, vinyl pivalate, vinyl propionate, vinyl stearate, and vinyl valerate), an allyl ether, a styrenic monomer (e.g., 4-tert-butoxystyrene, 4-(tert-butyl)styrene, 4-chloromethylstyrene, chloromethylstyrene, 3-chlorostyrene, 2 (diethylamino)ethylstyrene, 2-methylstyrene, 4-methylstyrene, 4-nitrostyrene, and 4 vinylbenzoic acid), a maleate, and combinations thereof. In some embodiments, the first or second PSA includes a pendent carboxylic acid group incorporated into the PSA by including, for example, acrylic acid, methacrylic acid, itaconic acid, maleic acid, or fumaric acid in the preparation of the PSA.

Crosslinked acrylic PSAs may be made, for example, by including one or more polyfunctional crosslinking monomers in the formulation. Suitable polyfunctional monomers include diacrylate esters of diols, such as ethylene glycol diacrylate, diethylene glycol diacrylate, propanediol diacrylate, butanediol diacrylate, butane-1,3-diyl diacrylate, pentanediol diacrylate, hexanediol diacrylate (including 1,6-hexanediol diacrylate), heptanediol diacrylate, octanediol diacrylate, nonanediol diacrylate, decanediol diacrylate, dimethacrylates of any of the foregoing diacrylates, and combinations thereof. Further suitable polyfunctional monomers include polyacrylate esters of polyols, such as glycerol triacrylate, trimethylolpropane triacrylate, pentaerythritol tetraacrylate, neopentyl glycol diacrylate, dipentaerythritol pentaacrylate, methacrylates of the foregoing acrylates, and combinations thereof. Further suitable polyfunctional crosslinking monomers include polyfunctional acrylate oligomers comprising two or more acrylate groups. The polyfunctional acrylate oligomer may be a urethane acrylate oligomer, an epoxy acrylate oligomer, a polyester acrylate, a polyether acrylate, a polyacrylic acrylate, a methacrylate of any of the foregoing acrylates, or a combination thereof.

Typically, the first monomer is used in an amount of 80 weight percent to 100 weight percent based on a total weight of monomers to make the acrylic polymer, and a second monomer as described above is used in an amount of 0 weight percent to 20 weight percent based on a total weight of monomers to make the acrylic polymer. In some embodiments, the first monomer is used in an amount of at least 90, 92, 95, 97, 98, or 99 percent by weight based on the total weight of the monomers, and the second monomer is used in an amount of up to 10, 8, 5, 3, 2, or 1 percent by weight based on the total weight of the monomers. When present, the polyfunctional crosslinking monomer can be used in an amount of 0.002 to 2 weight percent based on the combined weight of the monomers, for example from about 0.01 to about 0.5 percent by weight or from about 0.05 to 0.15 percent by weight.

The crosslinked acrylic-based PSAs useful for the double-sided PSA tape of the present disclosure can be prepared, for example, by a solvent free, free-radical polymerization process (e.g., using heat, electron-beam radiation, or ultraviolet radiation). Such polymerizations are typically facilitated by a polymerization initiator (e.g., a photoinitiator or a thermal initiator).

In some embodiments of the double-sided PSA tape of the present disclosure, at least one of the first PSA or the second PSA is derived from a composition comprising monomer including at least one alkyl acrylate monomer having from 4 to 18 carbon atoms and a polymer prepared from the partial polymerization of the at least one alkyl acrylate monomer. The composition is a solution of polymer in the at least one monomer and can be, for example, about 3 percent to 15 percent polymerized. In some embodiments, the composition comprises at least 75, 80, 85, 90, or 95 percent by weight monomer(s), based on the total weight of the composition. The at least one alkyl acrylate can be any of those first monomers described above having 4 to 18, 4 to 16, 4 to 12, 6 to 12, or 8 to 12 carbon atoms and may be present in any of the amounts described above. In some embodiments, the at least one alkyl acrylate is linear or branched. In some embodiments, the composition further comprises at least one of the second monomers described above in any of the amounts described above. In some embodiments, the composition further comprises at least one of acrylic acid, methacrylic acid, acrylamide, acrylonitrile, methacrylonitrile, an N-substituted acrylamide, a hydroxyalkyl acrylate, N-vinyl caprolactam, N-vinyl pyrrolidone, maleic anhydride, or itaconic acid. In some embodiments, the composition further comprises a crosslinker and a photoinitiator. The crosslinker can be, for example, any of the polyfunctional crosslinking monomers described above in any of the amounts described above. In some embodiments, the composition is exposed to ultraviolet radiation to provide at least one of the first pressure-sensitive adhesive or the second pressure-sensitive adhesive.

A useful solvent-free polymerization method is disclosed in U.S. Pat. No. 4,379,201 (Heilmann et al.). Initially, a mixture of first and second monomers can be polymerized with a portion of a photoinitiator by exposing the mixture to UV radiation in an inert environment for a time sufficient to form a coatable base syrup, and subsequently adding a crosslinking agent and the remainder of the photoinitiator. This final syrup containing a crosslinking agent (e.g., which may have a Brookfield viscosity of about 500 centipoise (cps) to about 10,000 cps at 23° C., about 100 cps to about 6000 cps at 23° C., or about 5,000 cps to about 7,500 cps at 23° C. as measured with a No. 4 LTV spindle, at 60 revolutions per minute) can then be coated onto a substrate. Once the syrup is coated onto the substrate, further polymerization and crosslinking can be carried out in an inert environment (e.g., nitrogen, carbon dioxide, helium, and argon, which exclude oxygen). A sufficiently inert atmosphere can be achieved by covering a layer of the photoactive syrup with a polymeric film, such as silicone-treated PET film, that is transparent to UV radiation or e-beam and irradiating through the film in air.

The composition including a monomer comprising at least one alkyl acrylate monomer having from 4 to 18 carbon atoms and a polymer prepared from the partial polymerization of the at least one alkyl acrylate monomer can be applied to the first and second surfaces of the tissue support using a variety of methods (e.g., dipping, spraying, brushing, roll coating, bar coating). In some embodiments, the composition can be coated on a liner with a notch bar with a gap setting to provide the desired thickness above the liner, followed by feeding the tissue support in the composition. A second composition, which may be the same or different, can be coated on top of the tissue support, and another liner may be added to maintain a gap of the desired thickness of the second composition.

Any suitable photoinitiator may be useful in the composition including the at least one alkyl acrylate monomer having from 4 to 18 carbon atoms and a polymer prepared from the partial polymerization of the at least one alkyl acrylate monomer. Suitable photoinitiators include type I or type II photoinitiators. Suitable photoinitiators may include acetophenones, benzilketal, alkylaminoacetophenones, benzoyl phosphine oxides, benzoin ethers, benzophenones, and benzoylformate esters. In some embodiments, the free radical photoinitiator is a type I (cleavage-type) photoinitiator. Cleavage-type photoinitiators include acetophenones, alpha-aminoalkylphenones, benzoin ethers, benzoyl oximes, acylphosphine oxides and bisacylphosphine oxides and mixtures thereof. Examples of useful photoinitiators include benzoin ethers (e.g., benzoin methyl ether or benzoin butyl ether); substituted acetophenone (e.g., 2,2-dimethoxy-2-phenylacetophenone, 2,2-diethoxyacetophenone, or 4-diethylaminoacetophenone); 1-hydroxycyclohexyl phenyl ketone; 2-benzyl-2 dimethylamino-4′-morpholinobutyrophenone; 2-hydroxy-2-methylpropiophenone and acylphosphonate derivatives (e.g., phenylbis(2,4,6-trimethylbenzoyl) phosphine oxide, diphenyl-2,4,6-trimethylbenzoylphosphine oxide, isopropoxyphenyl-2,4,6-trimethylbenzoylphosphine oxide, 2,4,6-trimethylbenzoylphenylethoxyphosphine oxide, or dimethyl pivaloylphosphonate). Many photoinitiators are available, for example, from BASF, Vandalia, Ill. under the trade designation “IRGACURE”, from IGM Resins, Waalwijk, Netherlands, under the trade designations “OMNIRAD” and “ESACURE”. The photoinitiator may be selected, for example, based on the desired wavelength for curing and compatibility with the composition. Any of these photoinitiators can also be useful, for example, to prepare the composition comprising at least one alkyl acrylate monomer having from 4 to 18 carbon atoms and a polymer prepared from the partial polymerization of the at least one alkyl acrylate monomer. Two or more of any of these photoinitiators may also be used together in any combination.

The photoinitiator can be used in any amount effective to facilitate polymerization of the monomers (e.g., 0.1 weight percent to about 5.0 weight or 0.2 weight to about 1.0 weight, based on the total weight of the monomers used to make the acrylic polymer).

In some embodiments, the composition comprising at least one alkyl acrylate monomer having from 4 to 18 carbon atoms and a polymer prepared from the partial polymerization of the at least one alkyl acrylate monomer includes a photocrosslinker. Examples of suitable photocrosslinkers include ethylenically unsaturated compounds which in the excited state are capable of abstracting hydrogen (e.g., acrylated benzophenones such as described in U.S. Pat. No. 4,737,559 (Kellen et al.)), p-acryloxybenzophenone, which is available from Sartomer Company, Exton, PA, monomers described in U.S. Pat. No. 5,073,611 (Rehmer et al.) including p-N-(methacryloyl-4-oxapentamethylene)-carbamoyloxybenzophenone, N-(benzoyl-p-phenylene)-N′-(methacryloxymethylene)-carbodiimide, and p-acryloxy-benzophenone), and para-acryloxyethoxybenzophenone; monofunctional benzophenones (including benzophenone, 4- phenylbenzophenone, 4-methoxybenzophenone, 4,4′-dimethoxybenzophenone, 4,4′-dimethylbenzophenone, 4-methylbenzophenone, 4-(2-hydroxyethylthio)-benzophenone, and 4-(4-tolylthio)-benzophenone), polyfunctional benzophenones (including di-esters of carboxymethoxy-benzophenone and polytetramethyleneglycol 250); anthraquinone photocrosslinkers (including anthraquinone, 2-methyl anthraquinone, 2-t-butyl anthraquinone, 2- ethyl anthraquinone, 2-phenyl anthraquinone, 1,4-dimethyl anthraquinone, 2,3-dimethyl anthraquinone, 1,2-dimethyl anthraquinone, 1-methoxy-2-methyl anthraquinone, 2-acetyl anthraquinone, and 2,6-di-t-butyl anthraquinone); thioxanthone photocrosslinkers (including thioxanthone, 2-isopropylthioxanthone, 2-chlorothioxanthone, 2-dodecylthioxanthone, 1-methoxycarbonylthioxanthone, 2-ethoxycarbonylthioxanthone, 3-(2-methoxyethoxycarbonyl)-thioxanthone, 4-butoxycarbonylthioxanthone, 3-butoxycarbonyl-7-methylthioxanthone, 1-cyano-3-chlorothioxanthone, 1 -ethoxycarbonyl-3-chlorothioxanthone, 1 -ethoxycarbonyl-3-ethoxythioxanthone, 1 -ethoxycarbonyl-3-aminothioxanthone, 1-ethoxycarbonyl-3-phenylsulfurylthioxanthone, 1-ethoxycarbonyl-3-(1-metyl-1-morpholinoethyl)-thioxanthone, 2-methyl-6-dimethoxymethylthioxanthone, 2-methyl-6-(1,1-dimethoxybenzyl)-thioxanthone, 2-morpholinomethylthioxanthone, 2-methyl-6-morpholinomethylthioxanthone, N-allylthioxanthone-3,4-dicarboxinilde, N-octylthioxanthone-3,4-dicarboximide, N-(1,1,3,3-tetramethylbutyl)-thioxanthone-3,4-dicarboximide, 6-ethoxycarbonyl-2-methoxythioxanthone; and 6-ethoxycarbonyl-2-methylthioxanthone)halomethyl- 1,3,5-triazines (e.g., 2,4-bis(trichloromethyl)-6-(4-methoxy)phenyl)-s-triazine; 2,4-bis(trichloromethyl)-6-(3,4-dimethoxy)phenyl)-s-triazine; 2,4-bis(trichloromethyl)-6-(3,4,5-trimethoxy)phenyl)-s-triazine; 2,4-bis(trichloromethyl)-6-(2,4-dimethoxy)phenyl)-s-triazine; 2,4-bis(trichloromethyl)-6-(3-methoxy)phenyl)-s-triazine as described in U.S. Pat. No. 4,330,590 (Vesley); 2,4-bis(trichloromethyl)-6-naphthenyl-s-triazine and 2,4-bis(trichloromethyl)-6-(4-methoxy)naphthenyl-s-triazine as described in U.S. Pat. No. 4,329,384 (Vesley)). The photocrosslinkers may be present in any useful amount, including in an amount of 0.001 to 10 weight percent, 0.001 to 5 weight percent, 0.001 to 2 weight percent, 0.001 to 1 weight percent, 0.001 to 0.5 weight percent, or 0.001 to 0.1 weight percent, based on the total weight of the composition.

Depending on the photoinitator or photocrosslinker used, the composition can be exposed to radiation having a wavelength of about 250 nm to about 500 nm, about 250 nm to about 450 nm, about 250 nm to about 400 nm, or about 280 nm to about 400 nm. Any suitable light source may be used, including a broadband light source (e.g., a fluorescent UV bulb, mercury lamp, or incandescent lamp) or a narrow band light source (e.g., LED or laser).

In some embodiments, at least one of the first PSA or the second PSA comprises a tackifier, useful for increasing the stickiness of the surface of the PSA. In some embodiments both first PSA and the second PSA comprise a tackifier, which may be the same tackifier or a different tackifier. In some embodiments, neither the first PSA nor the second PSA comprises a tackifier.

Useful tackifiers can have a number average molecular weight of up to 10,000 grams per mole, a softening point of at least 70° C. as determined using a ring and ball apparatus, and a glass transition temperature of at least -30° C. as measured by differential scanning calorimetry. Useful tackifiers are typically amorphous. In some embodiments, the tackifier is miscible with the acrylic polymer of the PSA such that macroscopic phase separation does not occur in the PSA. In some embodiments, the PSA is free of microscopic phase separation as well. In some embodiments, the tackifier comprises at least one of rosin, a rosin ester, an ester of hydrogenated rosin, a polyterpene (e.g., those based on α-pinene, β-pinene, or limonene), an aliphatic hydrocarbon resin (e.g., those based on cis- or trans-piperylene, isoprene, 2-methyl-but-2-ene, cyclopentadiene, dicyclopentadiene, or combinations thereof), an aromatic resin (e.g. those based on styrene, α-methyl styrene, methyl indene, indene, coumarone, or combinations thereof), or a mixed aliphatic-aromatic hydrocarbon resin. Any of these tackifying resins may be hydrogenated (e.g., partially or completely). Examples suitable tackifiers include those obtained under the trade designations “FORAL 85E” (a glycerol ester of highly hydrogenated refined gum rosin) commercially available from Eastman, Middelburg, NL, “FORAL 3085” (a glycerol ester of highly hydrogenated refined wood rosin) commercially available from Pinova, Brunswick, GA; “ESCOREZ 2520” and “ESCOREZ 5615” (aliphatic/aromatic hydrocarbon resins) commercially available from ExxonMobil Corp., Houston, TX; and “REGALITE 7100” (a partially hydrogenated hydrocarbon resin) commercially available from Eastman, Kingsport, Tennessee.

In some embodiments, at least one of the first PSA or the second PSA includes at least about one percent by weight and up to about 50 percent by weight of the tackifier, based on the total weight of the PSA. In some embodiments, the tackifier is present in a range from 1 to 25, 2 to 20, 2 to 15, 1 to 10, or 3 to 10 percent by weight, based on the total weight of the PSA.

Plasticizers may be added, e.g., to reduce vitrification of the cured composition. Suitable plasticizers include various polyalkylene oxides (e.g., polyethylene oxides or propylene oxides), adipic acid esters, formic acid esters, phosphoric acid esters, benzoic acid esters, phthalic acid esters, polyisobutylenes, polyolefins, and sulfonamides, naphthenic oils, plasticizing aids such as those materials described as plasticizers in the Dictionary of Rubber, K. F. Heinisch, pp. 359, John Wiley & Sons, New York (1974), oils, elastomer oligomers, and waxes. The amount of plasticizer employed, if one is employed, will depend on the nature of the plasticizer and its compatibility with the PSA.

In some embodiments, at least one of the first PSA or second PSA is substantially solvent free. Common organic solvents include aliphatic and alicyclic hydrocarbons (e.g., hexane, heptane, and cyclohexane), hydrocarbon solvents (e.g., benzene, toluene, xylenes, and d-limonene); acyclic and cyclic ketones (e.g., acetone, methyl ethyl ketone, and methyl isobutyl ketone, pentanone, hexanone, cyclopentanone, and cyclohexanone); ethers (e.g., diethyl ether, glyme, diglyme, diisopropyl ether, and tetrahydrofuran), esters (e.g., ethyl acetate and butyl acetate), sulfoxides (e.g., dimethyl sulfoxide), amides (e.g., N,N-dimethylformamide, N,N-dimethylacetamide, and N-methyl-2-pyrrolidone), halogenated solvents (e.g., methylchloroform, 1,1,2-trichloro-1,2,2-trifluoroethane, trichloroethylene, and trifluorotoluene), and alcoholic solvents (e.g., methanol, ethanol, or propanol such as isopropanol). The first or second PSA or both the first and second PSA can be substantially free of any of these solvents. The term “substantially free” means that at least one of the first or second PSA can include up to 0.5, 0.1, 0.05, or 0.01 percent by weight of any of these solvents or can be free of any of these solvents. These percentages are based on the total weight of the first or second PSA.

A number of additives may also be useful in the at least one of the first or second PSA. Examples of such adjuvants include antioxidants, such as hindered phenols, amines, and sulfur and phosphorous hydroperoxide decomposers; inorganic fillers such as talc, zinc oxide, titanium dioxide, aluminum oxide, and silica; pigments; dyes; stabilizers (e.g., ultraviolet absorbers, hindered amine light stabilizers, and heat stabilizers); fire retardants; and viscosity adjusting agents. The amounts of these can be selected so as to not interfere with the impregnation of the tissue support by the first and second PSA.

Depending on the amount of any of the tackifiers, plasticizers, and additives described above, in some embodiments, at least one of the first PSA or the second PSA may include at least 50, 60, 70, 80, 90, 95, 98, or 99 weight percent of the acrylic polymer described above in any of its embodiments.

The first and second PSAs useful in the double-sided PSA tape of the present disclosure may suitably have a variety of thicknesses, in some embodiments, a thickness of 0.001 inches to 0.1 inch (about 0.0254 millimeters (mm) to 2.54 mm). In some embodiments, the first and/or second PSA has a thickness of 0.002 inches to 0.025 inches (about 0.0508 mm to 0.635 mm) or a thickness of 0.002 inches to 0.02 inches (about 0.0508 mm to 0.508 mm). In some embodiments, the first and/or second PSA has a thickness of 0.001 inches to 0.01 inches (about 0.0254 mm to 0.254 mm). In some of these embodiments, the first and/or second PSA is a continuous layer. The term “continuous” as used herein means having an uninterrupted extension along a two-dimensional surface.

In some embodiments of the double-sided pressure-sensitive adhesive tape of the present disclosure, the tissue support is impregnated by the first and second PSAs. The term “impregnated” as used herein refers to at least one of the first or second PSAs being present throughout the thickness of the tissue. However, it should be understood that defects can be present such that localized areas of the tissue support may not be fully penetrated while the tissue support is still considered impregnated. Evidence of the first and second PSAs impregnating the tissue support can be provided by a variety of observations. In some embodiments, evidence of the first and second PSAs impregnating the tissue support includes that the double-sided pressure-sensitive adhesive tape exhibits not more than 65 percent haze as measured by ASTM D-1003. In some embodiments, evidence of the first and second PSAs impregnating the tissue support includes that the double-sided pressure-sensitive adhesive tape has not more than 25 percent area occupied by air bubbles as measured by optical microscopy. In some embodiments, evidence of the first and second PSAs impregnating the tissue support includes that a continuous layer of tissue support is not observable or barely observable in a cross section of the tape by scanning electron microscopy at 100 times magnification. The word “continuous” with regard to this layer means a distinct tissue layer that extends the entire length of the cross section, from left to right. In some embodiments, there is interlayer mixing between the first PSA and the second PSA in the interior of the tissue support. Advantageously, the tissue support being impregnated by the PSA can allow the adhesive to stay bonded to the tissue support when the tape is applied to substrate and subsequently removed.

In some embodiments, the double-sided pressure-sensitive adhesive tape exhibits not more than 65 percent haze as measured by ASTM D-1003. As described above, haze is the ratio of diffuse transmittance to total transmittance, where the diffuse transmittance is measured with the direct beam entering a light trap and thus not contributing to the measurement and is measured using a BYK-Gardner Hazegard instrument that conforms to ASTM D-1003 “Standard Test Method for Haze and Luminous Transmittance of Transparent Plastics.” In some embodiments, the double-sided PSA tape exhibits not more than 64, 63, 62, 61, or 60 percent haze.

In some embodiments, the double-sided pressure-sensitive adhesive tape has not more than 25, 20, 15, or 10 percent area occupied by air bubbles as measured by optical microscopy. The percentage of air bubbles is measured by optical microscopy using the method described in the Examples, below. As shown in the Examples, below, it was observed that the samples with lower percentage area of bubbles (Example 1 and Example 2) had significantly lower haze and higher transmission than the samples with high percentage area of bubbles (Comparative Examples C1 - C6). In general, interfaces between different materials (for example, the surface of a bubble in an adhesive) reflect a portion of incident light. The reflected intensity increases with the difference in refractive index on either side of the interface. When light is incident at an angle (i.e., not perpendicular) to the interface, the portion of the light that is transmitted across the interface will be deviated according to Snell’s Law. The greater the ratio of refractive indices of the materials on either side of the interface, the greater this deviation. As a result, the effect of air (or some other gas) bubbles in a solid matrix (e.g., an adhesive layer) is to reflect some light back the way it came thus reducing transmission as well as changing the direction of light that is transmitted through the bubbles thus increasing haze. The higher the percent area with air bubbles, the higher the haze and the lower the transmission. Thus, the high transmission and low haze of Example 1 and 2 are related to the low percent area with air bubbles.

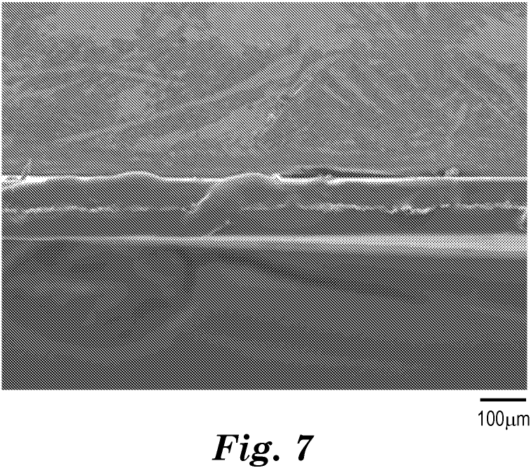

As shown in the Examples, below, double-sided tissue tapes that are prepared from hot melt adhesives or solvent-based adhesives do not have adhesive that impregnates the tissue support. This is evidenced by higher haze that is observed for hot melt or solvent-based PSAs coated on a tissue support (e.g., at least 69, 70, 75, or 80 percent haze) and/or by a higher percent area occupied by air bubbles as evidenced by optical microscopy (e.g., at least 40, 50, 60, or 70 percent area occupied by air bubbles.) Also, as shown by scanning electron microscopy, the images of double-sided tissue tape produced with solvent based adhesives (represented by Comparative Example 5 in FIG. 7) and that produced with hot melt adhesives (represented by Comparative Example 3 in FIG. 6) showed a distinct layer of tissue between two layers of adhesive. It has been observed in these comparative tissue tapes that this weak tissue layer often splits when the tissue tape is removed from a surface. The impregnation of the tissue support by the first and second PSAs in the double-sided tissue tape disclosed herein is expected to minimize tissue splitting.

In some embodiments, the tape of the present disclosure includes a release liner. Various release liners may be useful. In some embodiments, the release liner comprises at least one of a polyester film, polyethylene film, polypropylene film, polyolefin coated polymer film, polyolefin coated paper, acrylic coated polymer film, and polymer coated kraft paper. The polyolefin coated film or paper may be polyethylene coated film or paper. Referring again to FIG. 1, the present disclosure provides a tape 100 comprising in which the first and second PSAs 130, 140 are attached to a release liners 150. The release liner can be useful, for example, when the tape is wound into a roll. In some embodiments, the release liner 150 is coated on at least one of the major surfaces with a release coating. In some embodiments both major surfaces of the release liner 150 are coated with a release coating. In this case, the release coating may the same or different on each of the major surfaces of the release liner 150. Examples of materials useful as release coatings for the release liners disclosed herein include acrylics, silicones, siloxanes, fluoropolymers, and urethanes. In some embodiments, a silicone coating is useful for facilitating release of the pressure sensitive adhesive.

The release liner may be produced using a variety of processing techniques. For example, liner processing techniques such as those disclosed in U.S. Pat. Appl. No. 2013/0059105 (Wright et al.) may be useful to produce a release liner suitable for practicing the present disclosure. A suitable liner processing technique may include applying a layer comprising a (meth)acrylate-functional siloxane to a major surface of a substrate and irradiating that layer in a substantially inert atmosphere comprising no greater than 500 ppm oxygen with a short wavelength polychromatic ultraviolet light source having at least one peak intensity at a wavelength of from about 160 nanometers to about 240 nanometers. Irradiating can at least partially cure the layer. In some embodiments, the layer is cured at a curing temperature greater than 25° C. The layer may be at a temperature of at least 50° C., 60° C. 70° C., 80° C., 90° C., 100° C., 125° C., or at least 150° C., in some embodiments, no more than 250° C., 225° C., 200° C., 190° C., 180° C., 170° C., 160° C., or 155° C.

The present disclosure provides an article that comprises a first substrate and the double-sided pressure-sensitive adhesive tape as described above in any of its embodiments, in which the first pressure-sensitive adhesive is bonded to a surface of the first substrate. In some embodiments, the article further comprises a second substrate, wherein the second pressure-sensitive adhesive is bonded to a surface of the second substrate. FIG. 2 illustrates an embodiment of an article 200 of the present disclosure. The article includes the double-sided PSA tape with a tissue support 220 having a first face 222 and a second face 224. A first PSA 230 is disposed on the first face 222 of the tissue support 220. A second PSA 240 is disposed on the second face 224 of the tissue support 220. In the illustrated embodiment, the first PSA 230 is bonded to a surface of the first substrate 260, and the second PSA 240 is bonded to a surface of the second substrate 270.

The surfaces of the first substrate 260 and the second substrate 270 may be any desired material. In some embodiments, at least one of the surface of the first substrate or the surface of the second substrate comprises at least one of metal, glass, a polymer, paper, a painted surface, or a composite. The material of the surface of the first and second substrate may be found throughout the substrate, or the surface may include a different material from the bulk of the substrate. In some embodiments, the surface of the first substrate and/or second substrate comprises at least one of metal (e.g., steel, stainless steel, or aluminum), glass (e.g., which may be coated with indium tin oxide, for example,), a polymer (e.g., a plastic, rubber, thermoplastic elastomer, or thermoset), paper, a painted surface, or a composite. A composite material may be made from any two or more constituent materials with different physical or chemical properties. When the constituents are combined to make a composite, a material having characteristics different from the individual components is typically achieved. Some examples of useful composites include fiber-reinforced polymers (e.g., carbon fiber reinforced epoxies and glass-reinforced plastic); metal matrix compositions, and ceramic matrix composites. The surface of at least one of the first or second substrates may include polymers such as polyolefins (e.g., polypropylene, polyethylene, high density polyethylene, blends of polypropylene), polyamide 6 (PA6), acrylonitrile butadiene styrene (ABS), polycarbonate (PC), PC/ABS blends, polyvinyl chloride (PVC), polyamide (PA), polyurethane (PUR), thermoplastic elastomers (TPE), polyoxymethylene (POM), polystyrene, poly(methyl) methacrylate (PMMA), and combinations thereof. The surface of at least one of the first or second substrate may also include a metal coating on such polymers. In some embodiments, at least one of the first or second substrate comprises a transparent material such as glass or a polymer (e.g., acrylic or polycarbonate).

The double-sided PSA tape and article of the present disclosure can be useful in a variety of applications. For example, the double-sided PSA tape can be useful for graphics attachment (e.g., branding or information graphics) and plastic assembly. Examples of useful substrate surfaces for graphics attachment include polypropylene, ABS, PC, aluminum, steel, and painted surfaces. Graphic films can be made, for example, from PUR or PVC. The double-sided PSA tapes of the present disclosure can also be useful for bonding dissimilar materials together. In some of these embodiments, the first substrate comprises a metal, and the second substrate comprises a rubber or plastic. In some embodiments, the first and second substrates are dissimilar plastics. The double-sided PSA tapes of the present disclosure can also be useful for foam lamination in which either the first or second substrate is a foam (e.g., a polymer foam such as polyurethane, EPDM, and polyethylene foam). The double-sided PSA tapes of the present disclosure can also be useful for packaging in which either the first or second substrate is a paper (e.g., polymer-coated paper) or paperboard.

The double-sided PSA tape of the present disclosure can have a wide variety of widths. Useful widths can include between 0.25 inches (0.635 cm) and 85 inches (216 cm) in width. In some embodiments, the width of the double-sided pressure-sensitive adhesive tape is at least 2.5 cm. In some embodiments, the width of the double-sided pressure-sensitive adhesive tape is at least 5 cm. In some embodiments, the width of the double-sided pressure-sensitive adhesive tape is at most 75 cm (29.5 inches), 45 cm (17.7 inches), 30.5 cm (12 inches), or 10 cm (3.9 inches).

### Some Embodiments of the Disclosure

In a first embodiment, the present disclosure provides a double-sided pressure-sensitive adhesive tape comprising:
a tissue support having a first face and a second face;
a first pressure-sensitive adhesive disposed on the first face of the tissue support; and
a second pressure-sensitive adhesive disposed on the second face of the tissue support,
wherein the first pressure-sensitive adhesive and the second pressure-sensitive adhesive are each crosslinked acrylic-based pressure-sensitive adhesives that are the same or different from each other, and wherein the tissue support is impregnated by the first pressure-sensitive adhesive and the second pressure-sensitive adhesive.

In a second embodiment, the present disclosure provides the double-sided pressure-sensitive adhesive tape of the first embodiment, wherein the double-sided pressure-sensitive adhesive tape exhibits not more than 65 percent haze as measured by ASTM D-1003.

In a third embodiment, the present disclosure provides the double-sided pressure-sensitive adhesive tape of the first or second embodiment, wherein the double-sided pressure-sensitive adhesive tape has not more than 25 percent area occupied by air bubbles as measured by optical microscopy.

In a fourth embodiment, the present disclosure provides a double-sided pressure-sensitive adhesive tape comprising:
a tissue support having a first face and a second face;
a first pressure-sensitive adhesive disposed on the first face of the tissue support; and
a second pressure-sensitive adhesive disposed on the second face of the tissue support,
wherein the first pressure-sensitive adhesive and the second pressure-sensitive adhesive are each crosslinked acrylic-based pressure-sensitive adhesives that are the same or different from each other, and wherein the double-sided pressure-sensitive adhesive tape exhibits not more than 65 percent haze as measured by ASTM D-1003.

In a fifth embodiment, the present disclosure provides the double-sided pressure-sensitive adhesive tape of the fourth embodiment, wherein the double-sided pressure-sensitive adhesive tape has not more than 25 percent area occupied by air bubbles as measured by optical microscopy.

In a sixth embodiment, the present disclosure provides a double-sided pressure-sensitive adhesive tape comprising:
a tissue support having a first face and a second face;
a first pressure-sensitive adhesive disposed on the first face of the tissue support; and
a second pressure-sensitive adhesive disposed on the second face of the tissue support,
wherein the first pressure-sensitive adhesive and the second pressure-sensitive adhesive are each crosslinked acrylic-based pressure-sensitive adhesives that are the same or different from each other, and wherein the double-sided pressure-sensitive adhesive tape has not more than 25 percent area occupied by air bubbles as measured by optical microscopy.

In a seventh embodiment, the present disclosure provides the double-sided pressure-sensitive adhesive tape of any one of the first to sixth embodiments, wherein at least one of the first PSA or the second PSA is derived from a composition comprising:
one or more monomers comprising at least one alkyl acrylate monomer having from 4 to 18 carbon atoms; and
a polymer prepared from the partial polymerization of the at least one alkyl acrylate monomer.

In an eighth embodiment, the present disclosure provides a double-sided pressure-sensitive adhesive tape comprising:
a tissue support having a first face and a second face;
a first pressure-sensitive adhesive disposed on the first face of the tissue support; and
a second pressure-sensitive adhesive disposed on the second face of the tissue support,
wherein the first pressure-sensitive adhesive and the second pressure-sensitive adhesive are each crosslinked acrylic-based pressure-sensitive adhesives that are the same or different from each other, and wherein at least one of the first PSA or the second PSA is derived from a composition comprising:
   one or more monomers comprising at least one alkyl acrylate having from 4 to 18 carbon atoms; and
   a polymer prepared from the partial polymerization of the at least one alkyl acrylate.

In a ninth embodiment, the present disclosure provides the double-sided pressure-sensitive adhesive tape of the seventh or eighth embodiment, wherein the composition comprises at least 80 percent by weight of the one or more monomers, based on the total weight of the composition.

In a tenth embodiment, the present disclosure provides the double-sided pressure-sensitive adhesive tape of the ninth embodiment, wherein the at least one alkyl acrylate has 4 to 16, 4 to 12, 6 to 12, or 8 to 12 carbon atoms.

In an eleventh embodiment, the present disclosure provides the tape of any one of the seventh to tenth embodiments, wherein the composition further comprises at least one of acrylic acid, methacrylic acid, acrylamide, acrylonitrile, methacrylonitrile, an N-substituted acrylamide, a hydroxyalkyl acrylate, N-vinyl caprolactam, N-vinyl pyrrolidone, maleic anhydride, or itaconic acid.

In a twelfth embodiment, the present disclosure provides the double-sided pressure-sensitive adhesive tape of any one of the seventh to eleventh embodiments, wherein the composition further comprises a crosslinker and a photoinitiator.

In a thirteenth embodiment, the present disclosure provides the double-sided pressure-sensitive adhesive tape of the twelfth embodiment, wherein the composition is exposed to ultraviolet radiation to provide at least one of the first pressure-sensitive adhesive or the second pressure-sensitive adhesive.

In a fourteenth embodiment, the present disclosure provides the double-sided pressure-sensitive adhesive tape of any one of the seventh to thirteenth embodiments, wherein the composition is substantially solvent free.

In a fifteenth embodiment, the present disclosure provides the double-sided pressure-sensitive adhesive tape of any one of the first to fourteenth embodiments, wherein the first pressure-sensitive adhesive and the second pressure-sensitive adhesive are the same pressure-sensitive adhesive.

In a sixteenth embodiment, the present disclosure provides the double-sided pressure-sensitive adhesive tape of any one of the first to fourteenth embodiments, wherein the first pressure-sensitive adhesive and the second pressure-sensitive adhesive are different pressure-sensitive adhesives.

In a seventeenth embodiment, the present disclosure provides the double-sided pressure-sensitive adhesive tape of any one of the first to sixteenth embodiments, wherein at least one of the first pressure-sensitive adhesive or the second pressure-sensitive adhesive comprises a tackifier.

In an eighteenth embodiment, the present disclosure provides the double-sided pressure-sensitive adhesive tape of the seventeenth embodiment, wherein both the first pressure-sensitive adhesive and the second pressure-sensitive adhesive comprise a tackifier.

In a nineteenth embodiment, the present disclosure provides the double-sided pressure-sensitive adhesive tape of any one of the first to sixteenth embodiments, wherein neither the first pressure-sensitive adhesive nor the second pressure-sensitive adhesive comprises a tackifier.

In a twentieth embodiment, the present disclosure provides the double-sided pressure-sensitive adhesive tape of any one of the first to nineteenth embodiments, wherein at least one of the first pressure-sensitive adhesive or the second pressure-sensitive adhesive is substantially solvent free.

In a twenty-first embodiment, the present disclosure provides the double-sided pressure-sensitive adhesive tape of any one of the first to twentieth embodiments, wherein the tissue support has a basis weight in a range from 7 grams per square meter to 26 grams per square meter, 10 grams per square meter to 26 grams per square meter, 10 grams per square meter to 20 grams per square meter, 7 grams per square meter to 20 grams per square meter, or 8 grams per square meter to 16 grams per square meter.

In a twenty-second embodiment, the present disclosure provides the double-sided pressure-sensitive adhesive tape of any one of the first to twenty-first embodiments, wherein the tissue support exhibits at least 80, 85, or 90 percent haze as measured by ASTM D-1003.

In a twenty-third embodiment, the present disclosure provides the double-sided pressure-sensitive adhesive tape of any one of the first to twenty-second embodiments, further comprising a release liner on at least one of the first pressure-sensitive adhesive or the second pressure-sensitive adhesive.

In a twenty-fourth embodiment, the present disclosure provides an article comprising:
a first substrate; and
the double-sided pressure-sensitive adhesive tape of any one of the first to twenty-first embodiments,
wherein the first pressure-sensitive adhesive is bonded to a surface of the first substrate.

In a twenty-fifth embodiment, the present disclosure provides the article of the twenty-fourth embodiment, wherein the surface of the first substrate comprises at least one of metal, glass, a polymer, paper, a painted surface, or a composite.

In a twenty-sixth embodiment, the present disclosure provides the article of the twenty-fourth or twenty-fifth embodiment, wherein the article further comprises a second substrate, and wherein the second pressure-sensitive adhesive is bonded to a surface of the second substrate.

In a twenty-seventh embodiment, the present disclosure provides the article of the twenty-sixth embodiment, wherein the surface of the second substrate comprises at least one of metal, glass, a polymer, paper, a painted surface, or a composite.

In a twenty-eighth embodiment, the present disclosure provides the article of the twenty-sixth or twenty-seventh embodiment, wherein the surface of the first substrate comprises at least one of polypropylene, acrylonitrile butadiene styrene, polycarbonate, steel, aluminum, or a painted surface.

In a twenty-ninth embodiment, the present disclosure provides the article of any one of the twenty-sixth to twenty-eighth embodiment, wherein the surface of the second substrate comprises a different material from the surface of the first substrate.

In a thirtieth embodiment, the present disclosure provides the article of any one of the twenty-sixth to twenty-ninth embodiments, wherein the second substrate comprises a graphic film.

In a thirty-first embodiment, the present disclosure provides the article of any one of the twenty-sixth to twenty-ninth embodiments, wherein the second substrate comprises a foam.

In order that this disclosure can be more fully understood, the following examples are set forth. It should be understood that these examples are for illustrative purposes only and are not to be construed as limiting this disclosure in any manner.

### EXAMPLES

Unless otherwise noted, all parts, percentages, ratios, etc. in the Examples and the rest of the specification are by weight. Unless otherwise indicated, all other reagents were obtained, or are available from fine chemical vendors such as Sigma-Aldrich Company, St. Louis, Missouri, or may be synthesized by known methods. The following abbreviations are used in this section: min = minutes, s = second, g = gram, nm = nanometer, m = meter, centimeter = cm, mm = millimeter, µm = micrometer or micron, gsm = grams per square meter, °C = degrees Celsius, °F = degrees Fahrenheit, rpm = revolutions per minute, mJ/cm² = milliJoules per square centimeter.

TABLE 1

Materials List

| | |
|---|---|
| DESIGNATION | DESCRIPTION |
| 2-EHA | 2-Ethylhexyl acrylate, obtained from BASF, Florham Park, NJ. |
| 2OA | 2-Octyl acrylate, prepared as described in US Pat. No. 9,102,774 (Clapper et al.) |
| 2-DA | 2-Dodecyl acrylate, prepared as described in US Pat. No. 9,102,774 |
| AA | Acrylic acid, obtained from BASF, Florham Park, NJ. |
| IOTG | Iso-octyl thioglycolate, obtained from Showa Denko Corp, Tokyo, Japan |
| HDDA | Hexanediol diacrylate, obtained from Allnex USA Inc, Alpharetta, GA |
| TMPTA | Trimethylolpropane Triacrylate, obtained from Allnex USA Inc |
| DPHA | Dipentaerythritol pentaacrylate, obtained under the trade designation “SR399LV” from Sartomer Americas, Exton, PA. |
| KAeBP | Benzophenone Photocrosslinker, prepared as described in US Pat. No. 10,189,771 (Benson et al.) |
| Irg 651 | 2,2-Dimethoxy-1,2-diphenylethan-1-one, obtained under the trade designation “IRGACURE 651” from BASF Corporation, Vandalia, IL. |
| Irg 1076 | Octadecyl-3-(3,5-di-tertthutyl-4-hydroxyphenyl)-propionate, obtained under the trade name “IRGANOX 1076” from BASF Corporation |
| Foral 85 | Glycerol ester of hydrogenated wood rosin, obtained under trade name “FORAL 85” from Pinova, Brunswick, GA |
| Foral 3085 | Glycerol ester of hydrogenated wood rosin, obtained under trade name “FORAL 3085” from Pinova |
| Tissue #1 | 10 gsm (6.5 lbs./ream) tissue, obtained from MBL, Shanghai, China |
| Tissue #2 | 20 gsm (12.5 lbs./ream) tissue, obtained from Domtar, Charlotte, NC |
| Tissue #3 | 13 gsm (8 lbs./ream) tissue, obtained from Twin Rivers Paper, Madawaska, ME |
| Tissue #4 | 16 gsm (10 lb./ream) tissue, obtained from Twin Rivers Paper |
| 58# PCK liner | 58 lbs. polycoated kraft liner (PCK), 2-side silicone-coated, obtained from 3M Company, St. Paul, MN |
| PET liner | A silicone release liner having a nominal thickness of 51 micrometers (0.002 inches), obtained from Dupont Teijin, Dupont Chemical Company, Wilmington, DE. |
| 3M 9988EG | Double Coated Tissue Tape (DCTT), obtained under the trade designation “3M 9988EG” from 3M Company |
| 3M 9080A | Double Coated Tissue Tape (DCTT), obtained under the trade designation “3M 9080 A” from 3M Company |
| 3M 9448A | Double Coated Tissue Tape (DCTT), obtained under the trade designation “3M 9448A” from 3M Company |
| 3M 55236A | Double Coated Tissue Tape (DCTT), obtained under the trade designation “3M 55236A” from 3M Company |
| 3M 966 | 3M Adhesive Transfer Tape (ATT), obtained under the trade designation “3M 966” from 3M Company |
| 3M 9627 | 3M Adhesive Transfer Tape (ATT), obtained under the trade designation “3M 9627” from 3M Company |

### TEST METHODS

### Optical Microscopy Image Generation and Area Bubble Measurements

Optical images were obtained using a digital microscope (VHX-2000E digital microscope, Keyence Corporation, Itasca, IL, United States), with a VH-Z20UR lens, set at 180x, in reflected flanking illumination, nominal field view of 1870 × 1404 microns, i.e. large enough to image both clusters of fibers and gaps between clusters. Images were converted to grayscale, then were threshold so as to select bright areas (air pockets), but not fibers without air pockets. The percent of bright areas (corresponding to air bubbles) was determined and recorded.

### SEM Microscopy Images

Cross sections of the samples were prepared by cutting with a #10 scalpel blade while the sample was sitting on a piece of dry ice. These were mounted on an aluminum stub and were sputter coated with gold/palladium. The specimens were examined using the JEOL 7001F Field Emission Scanning Electron Microscope (JEOL USA, Inc., 11 Dearborn Road, Peabody, MA). All images were the product of secondary electron imaging (SEI), used to image surface morphology of a sample.

### Transmittance (T), Haze (H), and Clarity (C) Measurements

Total luminous Transmittance (T), Haze (H), and Clarity (C) were measured using Gardner Hazegard instrument (BYK-Gardner, Geretsried, Bayern, Germany) that conforms to ASTM D-1003 “Standard Test Method for Haze and Luminous Transmittance of Transparent Plastics.”

Total transmittance (T) is the signal measured at the detector (off-axis in an integrating sphere), normalized by the signal without a sample. Haze (H) is the ratio of the diffuse transmittance to the total transmittance, where diffuse transmittance was measured with the direct beam entering a light trap and thus not contributing to the measurement. Clarity (C) is the ratio of the difference between difference between the central beam and the low-angle scatter, and the sum of the central beam and the low-angle scatter.

The bulk transmittance, haze, and clarity were measured over a circular area approximately one inch in diameter using a white light source with a spectrum defined in the standard. Three sections from each sample were measured. Two samples, C1 and C2, (3M 966 and 3M 9627) were adhered to a clean glass slide to measure. The slide was measured to have very high transmission and clarity and very low haze, as shown in Table 8, below.

### PREPARATORY EXAMPLES

### Preparatory Examples 1 and 2 - Base Syrup

Polymer syrups were prepared by charging all the monomers and initiator in a gallon jar according to formulations shown in Table 2. The mixture was stirred until the photo-initiator had dissolved and a homogeneous mixture was obtained. Next the homogenous mixture was degassed, and any oxygen removed, by introducing nitrogen gas into it through a tube inserted through an opening in the jar’s cap and bubbling vigorously for at least 5 minutes. While maintaining stirring, the mixture was exposed to UV-A light until the temperature rose 11° C. and a polymer/monomer syrup having a viscosity deemed suitable for coating was formed. Following UV exposure, air was introduced into the jar. The light source was an array of LEDs having a peak emission wavelength of 365 nm.

TABLE 2

Preparatory Examples 1 and 2 - Base Syrup

| | | 2 EHA | AA | Irg 651 | Temp. rise |
|---|---|---|---|---|---|
| Sample | Batch size (g) | (g) | (g) | (g) | °C |
| P1 | 1750 | 1663 | 87.5 | 0.7 | 11 |
| P2 | 1750 | 1663 | 87.5 | 0.7 | 11 |

### Preparatory Examples 3 and 4 - Adhesive

Preparatory Examples 1 and 2 were further compounded with additional photoinitiator, crosslinker, and tackifiers according to the formulation shown in Table 3 and labelled Preparatory Example 3 and 4. A final homogeneous mix was prepared by rolling the jars for at least four hours.

TABLE 3

Preparatory Examples 3 and 4 - Adhesive

| | | | Coating Additions 15 | | |
|---|---|---|---|---|---|
| Adhesive Sample | Base syrup | Base syrup (g) | Irg 651 (g) | DPHA (g) | Foral 85 (g) |
| P3 | P1 | 1750 | 3.5 | 3.5 | 0.0 |
| P4 | P2 | 1750 | 3.5 | 3.5 | 105.0 |

### EXAMPLES AND COMPARATIVE EXAMPLES

### Example 1 (EX1)

Preparatory Example P3 was coated on a 2 mil (50 microns) polyester ((PET) liner via a notch bar with a gap setting of approximately 3 mil (75 microns) above the liner, followed by feeding Tissue #1 in the wet adhesive. It was followed by a second layer of adhesive coating on top of the same tissue and feeding another 2 mil PET (50 microns) liner to maintain gap of approx. 3 mil (75 micron) above the 2^{nd} layer of adhesive.

The total laminate was then exposed to a total UV-A energy of approximately 600 mJoules/cm² using a plurality of LED lamps with a peak emission wavelength of 365 nm. The UV radiation was applied through both sides of the PET liners. A total of 600 mJ/cm² was applied. A double coated tissue tape (DCTT) was obtained between two PET liners. The two PET liners were removed and replaced with a 58 # PCK liner.

### Example 2 (EX2)

Example 2 was prepared according to the method of Example 1 except that tackified adhesive Preparatory Example P4 with the formulation shown in Table 3 was used instead of Preparatory Example P3.

### Comparative Examples 1-2 (C1-C2)

DCTTs (C1 and C2) were prepared using a hot melt coating process. Adhesives produced via this process are described in U.S. 9,695,343 (Satrijo et al.) Synthesis Example 1 with changes according to Table 4 without Foral 3085 tackifier. The tackifier was added during subsequent process described in Example 1 of US 9,695,343 without any fibers and coated on a silicone-coated liner. The adhesive-coated liner was passed through an oven maintained at 250° F. (121° C.) for 42 second, and then laminated to tissue, followed by UV radiation and curing as described in Example 1 of US 9,695,343. During the second coating operation, another layer of adhesive was applied to a second silicone-coated liner, passed through an oven maintained at 250° F. (121° C.), cured through a UV chamber, and then laminated to the exposed tissue side of the material produced in the first coating step. One of the two liners was then removed.

TABLE 4

Comparative Examples 1-2 (C1-C2)

| Sample | Materials (g) | | | | | | | | | | UV Dosage (mJ/cm²) |
|---|---|---|---|---|---|---|---|---|---|---|---|
| | 2-EHA | 2-OA | 2-DA | AA | IOTG | HDDA | KAEBP | Irg 1076 | Irg 651 | Foral 3085 | |
| C1 | | 75 | 19.5 | 6 | 0.1 | 0.07 | 0.2 | 0.2 | 0.15 | 32 | 250 |
| C2 | 94.5 | | | 6 | 0.1 | 0.07 | 0.25 | 0.2 | 0.15 | 40 | 250 |

### Comparative Example 3 (C3)

Comparative Example 3 was 3M 55236A, described above.

### Comparative Examples 4-6 (C4-C6)

Commercially available solvent-coated DCTTs were labelled C4, C5, and C6 according to Table 5. C4 represents a DCTT produced with a non-tackified acrylic adhesive, while C5 and C6 are tackified acrylic adhesives.

TABLE 5

Comparative Examples 4-6 (C4-C6) - DCTT Samples produced with solvent based PSAs

| | |
|---|---|
| Sample | DCTT |
| C4 | 3M 9988EG |
| C5 | 3M 9080A |
| C6 | 3M 9448A |

### Comparative Examples 7 and 8 (C7-C8)

Commercially available transfer tapes with no tissue substrate used for optical comparisons are labeled as C7, C8 according to Table 6.

TABLE 6

Comparative Examples 7-8 (C7-C8) - ATT Samples

| | |
|---|---|
| Sample | ATT |
| C7 | 3M 966, ATT |
| C8 | 3M 9627, ATT |

### RESULTS

### Optical Microscopy Image Generation and Area Bubble Measurements

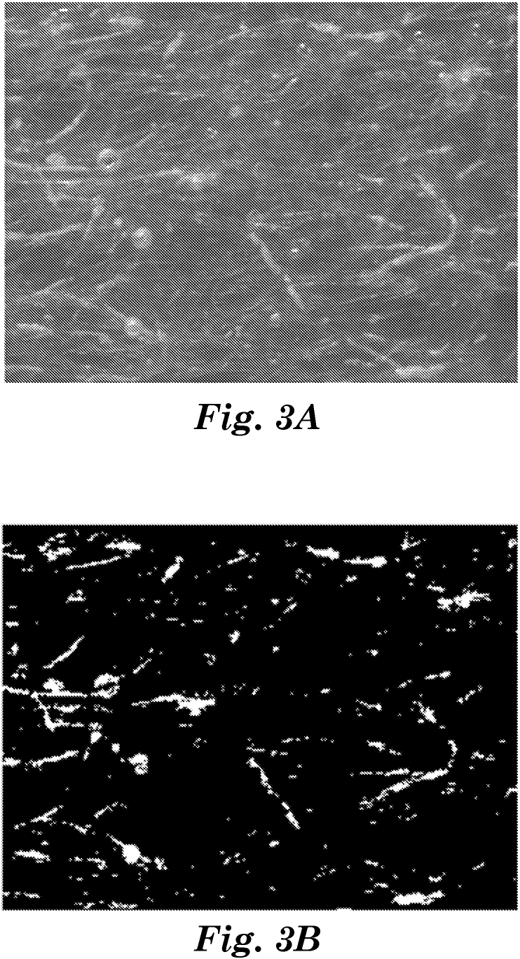

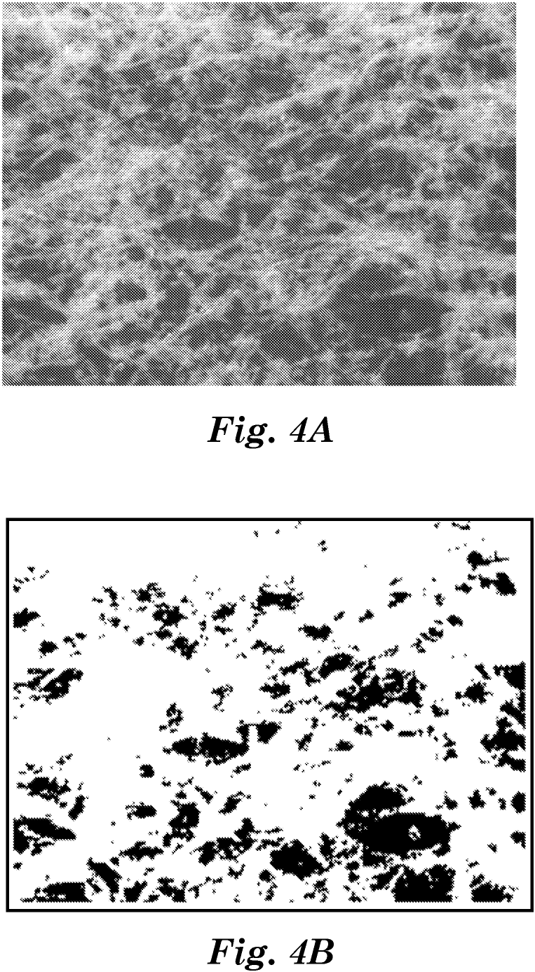

The images representing DCTT produced with solvent based adhesives and those produced with hot melt adhesives all showed substantial levels of tissue and air bubbles, whereas Examples 1 and 2 showed little uncoated tissue and relatively few air bubbles. Results showing corresponding area bubble measurements are included in Table 7 below. The images for Example 1 are shown in FIGS. 3A and 3B. The images for Comparative Example C3 are shown in FIGS. 4A and 4B.

TABLE 7

Area Bubble Measurements for Examples 1-2 (EX1-EX2) and Comparative Examples (C1-C8)

| Sample | Description | % Area Air Bubbles | |
|---|---|---|---|
| | | mean % | stdev % |
| EX1 | Example | 4.84 | 0.28 |
| EX2 | Example | 2.75 | 0.71 |
| C1 | Hot melt applied PSA | 66.06 | 2.57 |
| C2 | Hot melt applied PSA | 65.69 | 3.05 |
| C3 | Hot melt applied PSA | 75.28 | 6.95 |
| C4 | Solvent applied PSA | 64.27 | 2.30 |
| C5 | Solvent applied PSA | 69.25 | 6.77 |
| C6 | Solvent applied PSA | 66.98 | 3.54 |
| C7 | Adhesive transfer tape | 0 | 0 |
| C8 | Adhesive transfer tape | 0 | 0 |

### SEM Microscopy Images

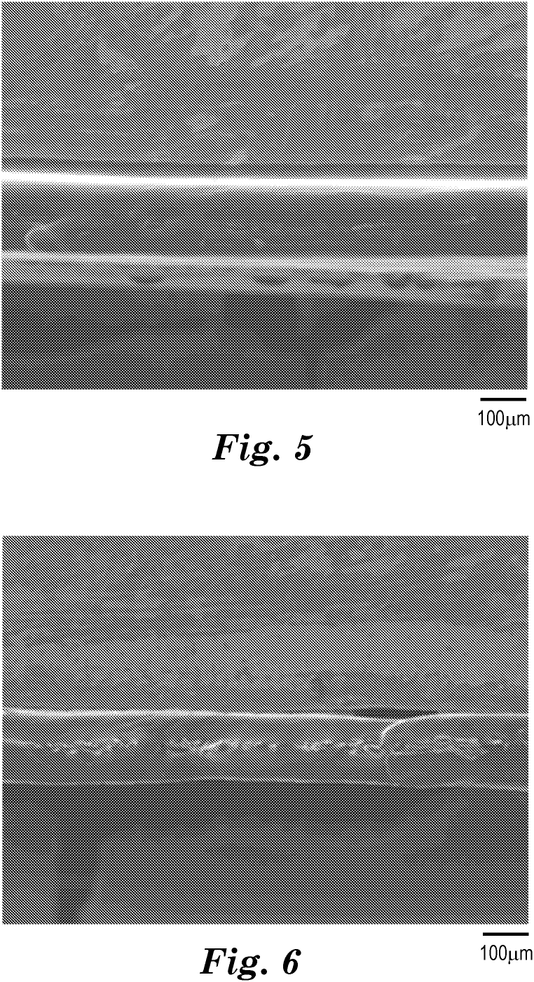

The images representing DCTT produced with solvent based adhesives and those produced with hot melt adhesives showed a distinct layer of tissue between two layers of adhesive. The adhesive does not impregnate the tissue. Examples 1 and 2 barely showed the presence of distinct layer of tissue because the tissue was impregnated with the adhesive. An image for representative hot melt applied PSA DCTT Comparative Example C3 is shown in FIG. 6. An image for representative solvent applied PSA DCTT Comparative Example C7 is shown in FIG. 7. An image for Example 1 is shown in FIG. 5.

TABLE 8

Transmission, Haze and Clarity Measurements of Various Samples

| Sample | Description | Transmission, T (%) | | Haze, H, (%) | | Clarity, C (%) | |
|---|---|---|---|---|---|---|---|
| | | mean | stdev | mean | stdev | mean | stdev |
| EX1 | Example | 91.10 | 0.17 | 55.67 | 0.42 | 39.90 | 0.70 |
| EX2 | Example | 90.90 | 0.20 | 55.10 | 1.04 | 36.67 | 0.40 |
| C1 | Hot melt applied PSA | 83.33 | 1.53 | 83.17 | 0.15 | 15.20 | 0.17 |
| C2 | Hot melt applied PSA | 84.03 | 1.03 | 80.57 | 0.74 | 21.97 | 1.22 |
| C3 | Hot melt applied PSA | 80.10 | 0.20 | 81.40 | 0.17 | 34.53 | 0.50 |
| C4 | Solvent applied PSA | 85.13 | 0.40 | 69.97 | 0.15 | 34.70 | 0.66 |
| C5 | Solvent applied PSA | 82.37 | 0.93 | 72.20 | 1.28 | 40.30 | 0.52 |
| C6 | Solvent applied PSA | 82.17 | 0.55 | 73.47 | 1.08 | 36.47 | 0.47 |
| C7 | ATT | 92.33 | 0.06 | 38.40 | 0.36 | 35.90 | 0.20 |
| C8 | ATT | 93.30 | 0.36 | 3.26 | 0.02 | 72.60 | 0.66 |
| T1 | Tissue #1, 10 gsm | 77.13 | 0.47 | 92.47 | 0.38 | 69.27 | 0.06 |
| T2 | Tissue #2, 20 gsm | 64.74 | 2.60 | 100.00 | 0.60 | 18.94 | 3.86 |
| T3 | Tissue #3, 13 gsm | 81.12 | 0.95 | 92.30 | 0.60 | 74.48 | 1.83 |
| T4 | Tissue #4, 16 gsm | 81.32 | 0.54 | 97.80 | 0.20 | 26.88 | 1.24 |
| Clean Slide | Glass slide | 93.37 | 0.50 | 0.51 | 0.41 | 99.90 | 0.00 |

The data shows that Examples 1 and 2 provided the highest transmittance and lowest haze compared to DCTT produced via solvent or hot melt coated processes (Comparative Examples C1 to C6). The transmission of Examples 1 and 2 approached that of the pure layer of adhesives, Comparative Examples C7 and C8, and even that of glass slide control. The haze of Examples 1 and 2 was significantly lower than that of Comparative Examples C1 to C6. Various tissue samples, Tissue #1-#4 (T1-T4), were also tested and shown to have high levels of haze, significantly higher than Examples 1 and 2.

This disclosure may take on various modifications and alterations without departing from its spirit and scope. Accordingly, this disclosure is not limited to the above-described embodiments but is to be controlled by the limitations set forth in the following claims and any equivalents thereof. This disclosure may be suitably practiced in the absence of any element not specifically disclosed herein.

1. A double-sided pressure-sensitive adhesive tape comprising:
a tissue support having a first face and a second face;
a first pressure-sensitive adhesive disposed on the first face of the tissue support; and
a second pressure-sensitive adhesive disposed on the second face of the tissue support,
wherein the first pressure-sensitive adhesive and the second pressure-sensitive adhesive are each crosslinked acrylic-based pressure-sensitive adhesives that are the same or different from each other, and wherein the tissue support is impregnated by the first pressure-sensitive adhesive and the second pressure-sensitive adhesive.

2. The double-sided pressure-sensitive adhesive tape of claim 1, wherein the double-sided pressure-sensitive adhesive tape exhibits not more than 65 percent haze as measured by ASTM D-1003.

3. The double-sided pressure-sensitive adhesive tape of claim 1, wherein the double-sided pressure-sensitive adhesive tape has not more than 25 percent area occupied by air bubbles as measured by optical microscopy.

4. The double-sided pressure-sensitive adhesive tape of claim 1, wherein at least one of the first pressure-sensitive adhesive or the second pressure-sensitive adhesive is derived from a composition comprising:
one or more monomers comprising at least one alkyl acrylate having from 4 to 18 carbon atoms; and
a polymer prepared from partial polymerization of the at least one alkyl acrylate.

5. The double-sided pressure-sensitive adhesive tape of claim 4, wherein the composition comprises at least 80 percent by weight of the one or more monomers, based on the total weight of the composition.

6. The double-sided pressure-sensitive adhesive tape of claim 4, wherein the one or more monomers further comprises at least one of acrylic acid, methacrylic acid, acrylamide, acrylonitrile, methacrylonitrile, an N-substituted acrylamide, a hydroxyalkyl acrylate, N-vinyl caprolactam, N-vinyl pyrrolidone, maleic anhydride, or itaconic acid.

7. The double-sided pressure-sensitive adhesive tape of claim 4, wherein the composition further comprises a crosslinker and a photoinitiator, and wherein the composition is exposed to ultraviolet radiation to provide at least one of the first pressure-sensitive adhesive or the second pressure-sensitive adhesive.

8. The double-sided pressure-sensitive adhesive tape of claim 1, wherein the first pressure-sensitive adhesive and the second pressure-sensitive adhesive are the same pressure-sensitive adhesive.

9. The double-sided pressure-sensitive adhesive tape of claim 1, wherein at least one of the first pressure-sensitive adhesive or the second pressure-sensitive adhesive comprises a tackifier.

10. The double-sided pressure-sensitive adhesive tape of claim 1, wherein at least one of the first pressure-sensitive adhesive or the second pressure-sensitive adhesive is substantially solvent free.

11. The double-sided pressure-sensitive adhesive tape of claim 1, wherein the tissue support has a basis weight in a range from 7 grams per square meter to 26 grams per square meter.

12. The double-sided pressure-sensitive adhesive tape of claim 1, wherein the tissue support exhibits at least 80 percent haze as measured by ASTM D-1003.

13. The double-sided pressure-sensitive adhesive tape of claim 1, further comprising a release liner on at least one of the first pressure-sensitive adhesive or the second pressure-sensitive adhesive.

14. An article comprising:
a first substrate; and
the double-sided pressure-sensitive adhesive tape of claim 1,
wherein the first pressure-sensitive adhesive is bonded to a surface of the first substrate.

15. The article of claim 14, wherein the article further comprises a second substrate, and wherein the second pressure-sensitive adhesive is bonded to a surface of the second substrate.

16. A double-sided pressure-sensitive adhesive tape comprising:
a tissue support having a first face and a second face;
a first pressure-sensitive adhesive disposed on the first face of the tissue support; and
a second pressure-sensitive adhesive disposed on the second face of the tissue support,
wherein the first pressure-sensitive adhesive and the second pressure-sensitive adhesive are each crosslinked acrylic-based pressure-sensitive adhesives that are the same or different from each other, and wherein the double-sided pressure-sensitive adhesive tape exhibits not more than 65 percent haze as measured by ASTM D-1003.

17. The double-sided pressure-sensitive adhesive tape of claim 16, wherein the double-sided pressure-sensitive adhesive tape has not more than 25 percent area occupied by air bubbles as measured by optical microscopy.

18. The double-sided pressure-sensitive adhesive tape of claim 16, wherein at least one of the first pressure-sensitive adhesive or the second pressure-sensitive adhesive is derived from a composition comprising:
one or more monomers comprising at least one alkyl acrylate having from 4 to 18 carbon atoms; and
a polymer prepared from partial polymerization of the at least one alkyl acrylate.

19. The double-sided pressure-sensitive adhesive tape of claim 16, wherein the first pressure-sensitive adhesive and the second pressure-sensitive adhesive are the same pressure-sensitive adhesive.

20. The double-sided pressure-sensitive adhesive tape of claim 16, wherein the tissue support exhibits at least 80 percent haze as measured by ASTM D-1003.
